(19) United States
(12) Patent Application Publication
(10) Pub. No.: US 2024/0110545 A1
(43) Pub. Date: Apr. 4, 2024

(54) ROTATABLE AIRFOIL STRUCTURE WITH INTEGRATED SOLAR PHOTOVOLTAIC ELECTRICITY GENERATION

(71) Applicant: Bradley Cook, Kihei, HI (US)

(72) Inventor: Bradley Cook, Kihei, HI (US)

(21) Appl. No.: 18/539,378

(22) Filed: Dec. 14, 2023

Related U.S. Application Data
(63) Continuation-in-part of application No. 17/307,640, filed on May 4, 2021, now Pat. No. 11,881,809.
(60) Provisional application No. 63/021,257, filed on May 7, 2020.

(51) Int. Cl. F03D 9/00; F03D 7/02; F03D 9/11; F03D 17/00; H02S 10/12

(52) U.S. Cl. CPC F03D 9/007; F03D 7/0204; F03D 9/11; F03D 17/015; H02S 10/12; F05B 2220/708

(57) ABSTRACT

A rotatable solar tower with an airfoil structure is described. Solar panels are stacked vertically to create the skin of an airfoil. By installing the airfoil vertically so that its longitudinal axis is perpendicular to the ground and allowing the airfoil to rotate freely 360 degrees into the wind, the horizontal forces on the airfoil from the wind are significantly reduced compared to a round cylinder with the same diameter. This allows the airfoil structure to be lightweight in design while spanning several hundred feet in height and producing several hundred kilowatts of electrical power on a small footprint of land. The solar panels may have 3-axes of rotation, i.e., rotation of the tower about the base, horizontal extension of the solar frame assemblies and vertical extension of the solar panels. Wind turbines may also be provided in or on the tower.

### CROSS-REFERENCE TO RELATED APPLICATIONS

This application claims priority to U.S. Provisional Application No. 63/021,257, filed May 7, 2020, and entitled “Rotatable Airfoil Structure With Integrated Solar Photovoltaic Electricity Generation”, U.S. patent application Ser. No. 17/307,640 filed May 4, 2021, and entitled “Rotatable Airfoil Structure With Integrated Solar Photovoltaic Electricity Generation”, and incorporates the entire contents of these applications herein.

### TECHNICAL FIELD

The present disclosure describes a solar tower, and more specifically a solar tower employing an integrated airfoil structure with 3-axes of solar panel rotation.

### BACKGROUND

Many solar installations have limited space to install the required number of panels for their solar project, have less than desirable solar angles based on latitude or poor azimuth and slope of a roof, contend with snow and ice covering panels during winter months and/or are located in high wind regions requiring heavy mounts to protect the panels from blowing away. These factors can limit the solar power output of a system or make installations too costly and potentially unfeasible.

Solar panels installed on the roofs of houses have a fixed angle and orientation, and a limited square foot area on how many panels can be installed. Roof-installed solar panels are also susceptible to damage due to high winds, hail, or ice and snow coverage during winter months in northern climates.

Solar fields require the purchase or lease of large plots of land with added expenses such as running power lines to the nearest utility grid. Current solar tower designs are fixed in place creating a large wind area that requires a much heavier and more expensive support structure and loose solar efficiency with only a single axis of rotation.

As stated above, many solar installations have limited space to install the required number of panels for their solar project, have less than desirable solar angles based on latitude or a poor azimuth and slope of a roof, and contend with snow and ice covering panels during winter months. Furthermore, such solar panel constructions located in high wind regions may require heavy mounts to protect the panels from blowing away. These factors can limit the solar power output of a system or make installations too costly and potentially unfeasible.

Accordingly, it would be advantageous to provide a solar installation that mitigates many or all of these problems.

### SUMMARY

In an embodiment, a solar tower installation uses solar panels as the skin of an airfoil while taking advantage of the rigidity of solar frames to strengthen the structure as a whole. The solar panels are attached to a shell which acts as the nose of the airfoil. The solar panels may be incorporated into individual solar frames. The solar frames may be connected vertically to form solar frame assemblies and include actuators to tilt the solar panels to capture more solar energy. The solar frame assemblies may be in an extended position, e.g., horizontally 90 degrees from the shell (nose) to capture more solar energy or in a closed position, to act as an airfoil.

Thus the solar panels may have 3-axes of rotation, i.e., 360 degree rotation of the tower about the base, horizontal extension of the solar frame assemblies from the closed airfoil position, to the fully extended position, and extension of the solar frames vertically from a closed, airfoil position to an extended position.

Should the winds exceed, for example, a certain threshold as determined by an internal weather sensor system or load sensors connected to the actuators, a control system may control the solar frames and solar frame assemblies to fold down and inwards, respectively, into an efficient airfoil structure while also controlling a base clutch to disengage the motor from a spur gear allowing free rotation of the tower. When the wind drops below another threshold, the clutch may reengage the motor to the spur gear and continue to track the sun and the new sun orientation for maximum power generation.

In an embodiment, the tower may include a wind turbine assembly with a second bearing. The wind turbine assembly may rotate with or independently from the airfoil and include internal brakes to stop and start based on weather conditions and power requirements. In most cases, the wind turbine will complement the solar panels, adding a more reliable energy stream for off-grid applications.

### BRIEF DESCRIPTION OF THE DRAWINGS

FIG. 1 is a perspective view of a solar tower installation including a wind turbine assembly according to an embodiment.

FIG. 2 is a perspective view of a solar tower installation according to another embodiment.

FIG. 3 is a plan view of a support frame assembly for the solar frame assemblies according to an embodiment.

FIG. 4 is a side view of a partially assembled solar frame according to an embodiment.

FIG. 5 shows an assembly of sections of the solar tower installation according to an embodiment.

FIG. 6 is a plan view of a support frame assembly for the solar frame assemblies according to another embodiment.

FIG. 7 is a side view of a partially assembled solar frame according to another embodiment.

FIG. 8 shows an assembly of sections of the solar tower installation according to another embodiment.

FIG. 9 is a plan view of an airfoil structure in the solar tower installation including cellular panels according to an embodiment.

FIG. 10 is a side view of an airfoil structure in the solar tower installation including cellular panels according to an embodiment.

FIG. 11 is a perspective view of a portion of the solar tower installation with solar panels partially extended vertically.

FIG. 12 is another view of a portion of the solar tower installation with solar panels partially extended vertically.

FIG. 13 is a sectional view of the shell of the solar tower installation according to an embodiment.

FIG. 14 is a sectional view of an airfoil structure according to an embodiment.

FIG. 15 is a perspective view of a solar tower installation with the solar frame assemblies and solar panels extended.

FIG. 16 is a perspective view of a base cabinet of the solar tower installation according to an embodiment.

FIGS. 17A-C show components including cellular panels, batteries and wind turbines installed in the solar tower installation according to an embodiment.

FIG. 18 is a front view of a solar tower installation including multiple horizontal axis wind turbines incorporated into the tower according to an embodiment.

FIG. 19A-C show various views of a base gear design including a slewing bearing assembly for the solar tower installation according to an embodiment.

FIG. 20 shows a base design for the solar tower installation according to another embodiment.

FIG. 21 is a schematic of a control unit for the solar tower installation according to an embodiment.

FIG. 22 is an elevation view of a solar tracking tower according to another embodiment.

FIG. 23A is a perspective view of a wing set module according to an embodiment.

FIG. 23B is a cutaway view showing mechanical connections between the shell and a wing according to an embodiment.

FIG. 24 is a perspective view of a base cabinet according to an embodiment.

FIG. 25 is a perspective view of the tower in a predawn orientation according to an embodiment.

FIG. 26 is a plan view of the tower and wing sets in a closed position according to an embodiment.

FIG. 27 is a perspective view of the tower with the wings in an open position according to an embodiment.

FIG. 28 is a perspective view of the tower with the wings in a solar tracking configuration according to an embodiment.

FIG. 29 is a perspective view of the tower with the wings in another solar tracking configuration according to an embodiment.

FIG. 30 is a perspective view of the tower with the wings in yet another solar tracking configuration according to an embodiment.

FIG. 31 is a perspective view of the tower with the wings in a closed position after a daily solar tracking cycle according to an embodiment.

FIG. 32A is a flowchart describing an exemplary daily solar tracking operation according to an embodiment.

FIG. 32B is a flowchart describing a wind speed monitoring and control operation according to an embodiment.

FIG. 33 is a block diagram of an equipment control module according to an embodiment.

FIG. 34 is a perspective view of an individual wing in a partially folded view during (dis)assembly of the tower according to an embodiment.

FIG. 35 is a perspective view of the tower including a fixed base at ground level and a bearing assembly above the fixed base to enable the upper portion of the tower including the wings to rotate.

### DETAILED DESCRIPTION

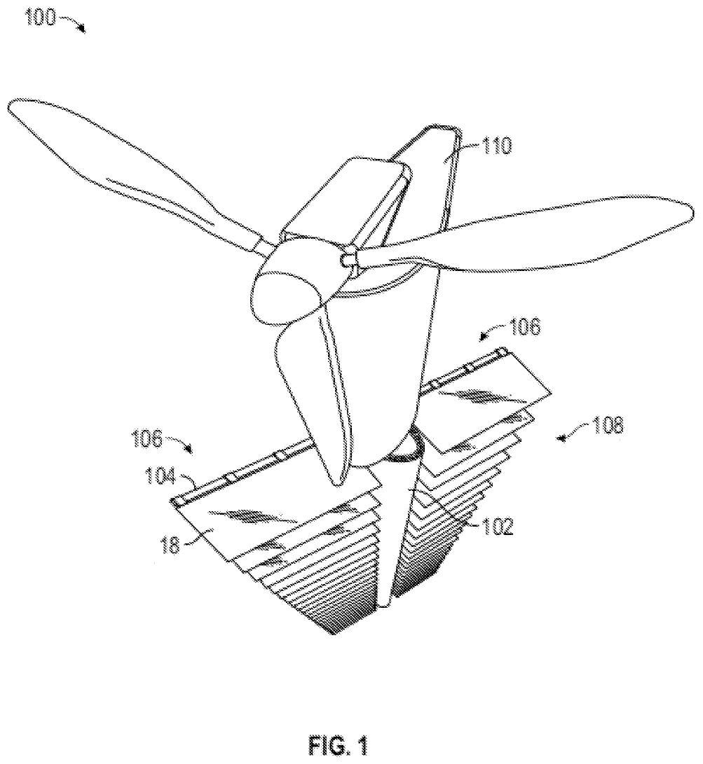

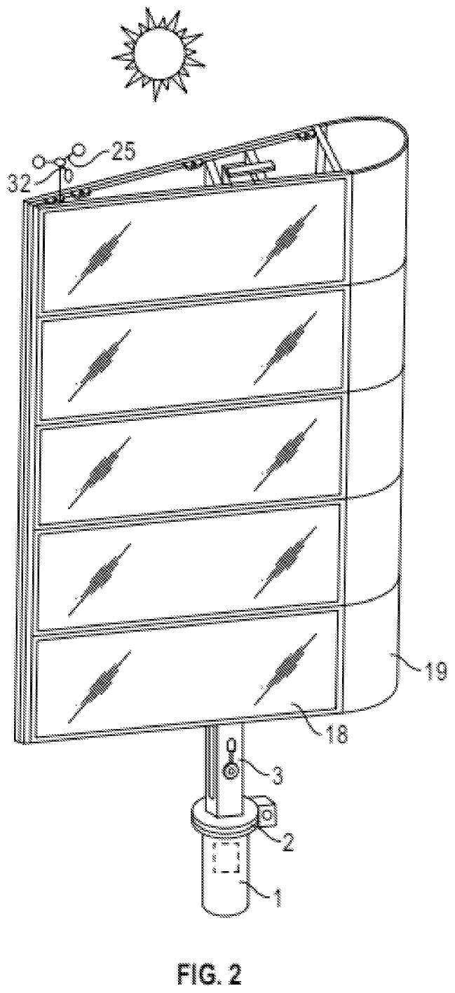

FIG. 1 shows an embodiment of a solar tower installation 100 that uses solar panels 18 as the skin of an airfoil 108 while taking advantage of the rigidity of each solar panel to strengthen the structure as a whole similar to sheets of plywood screwed to the trusses of a home. The solar panels 18 are attached to a shell 102 which acts as the nose of the airfoil. The solar panels 18 may be incorporated into individual solar frames 104. The solar frames may be connected vertically to form solar frame assemblies 106. The solar frame assemblies 106 may be in an extended position, e.g., horizontally 90 degrees from the shell (nose) 102, as shown in FIG. 1, to capture more solar energy, or in a closed position, as shown in FIG. 2, to act as an airfoil.

Thus the solar panels may have 3-axes of rotation, i.e., 360 degree rotation of the tower 100 about the base, horizontal extension of the solar frame assemblies 106 from the closed airfoil position, as shown in FIG. 2, to the fully extended position, as shown in FIG. 1, and extension of the solar frames 104 vertically from a closed, airfoil position, as shown in FIG. 2, to an extended position, as shown in FIG. 1.

Should the winds exceed, for example, 30 mph, the solar frames 104 and solar frame assemblies 106 fold down and inwards, respectively, into an efficient airfoil structure while a base clutch disengages the motor from a spur gear allowing free rotation of the tower, which in an embodiment, may be rated for a 200 mph survival wind speed. When the wind drops below, for example, 10 mph for 10 minutes with an improving weather forecast, the clutch may reengage the motor to the spur gear and continue to track the sun and the new sun orientation for maximum power generation.

In an embodiment, the tower 100 may include a wind turbine assembly 110 with a second bearing installed just above the top solar frame to allow the airfoil to act as a tail keeping the wind turbine into the wind. The wind turbine could include, for example, a 5 kw or 10 kw varying pitch control wind turbine. The wind turbine assembly may rotate with or independently from the airfoil and include internal brakes to stop and start the rotation of the wind turbine blades based on weather conditions and power requirements. In most cases, the wind turbine will complement the solar panels, adding a more reliable energy stream for off-grid applications.

Using solar panels as the skin of an airfoil allows the airfoil structure to maintain the smooth uninterrupted flow of air over the contour of the wing and allows the airfoil structure to freely rotate 360 degrees into the wind, significantly reducing the structures drag coefficient. This allows the structure to be much lighter in construction, taller in height offering increased photovoltaic electricity generation capacity in a smaller footprint of land while reducing material and installation costs.

In an embodiment, the tower 100 may be extended up to 200 feet in height, depending on the size and number of solar panels, and withstand winds up to 200 mph. Solar, wind, cellular, electric vehicle (EV) equipment racking, inverters, lithium (Li) power packs, hydrogen generators, hydrogen storage tanks and hydrogen fuel cells may be integrated seamlessly into the tower based on the intended use. The electrical power provided by the tower may be used for a variety of applications, including residential, cellular, commercial, utilities, EV stations, and off-grid applications.

Previous solar towers or pedestals are fixed in place, requiring a much heavier and more costly support structure and foundation to handle the increased wind loading on panels oriented towards the sun. Having fixed solar panels on a rooftop or tower installation will significantly reduce the power output of each solar panel throughout the year, requiring more panels to be installed increasing costs. Solar panel pedestal mounts that can rotate with the direction of the sun are limited to a fixed number of panels each pedestal can support, require a larger footprint of land with increased installation and maintenance costs. Fixed solar towers are also limited on the number of panels they can support without an expensive foundation and support structure.

By installing the airfoil vertically so that its longitudinal axis is perpendicular to the ground and allowing the airfoil to rotate freely 360 degrees into the wind, the horizontal forces on the airfoil from the wind are significantly reduced by up to five times that of a round cylinder with the same diameter or 20 twenty times that of a flat surface area with the same width. This allows the airfoil structure to be designed several hundred feet in height, producing several hundred kilowatts of electrical power on a small footprint of land. For example, the vertical footprint may use less than 10% of land space over fixed solar arrays reducing land costs while providing more solar tower installation location options.

By incorporating solar panels within the airfoil structure and providing 3-axes of rotation (rotation of the tower about the base, opening outwards horizontally and tilting from 0 degrees vertically to 90 degrees horizontally), the power output of each solar panel is significantly increased over conventional solar installs with a more linear power output throughout the year. With full 3-axis, computer controlled solar tracking (described below), solar output may increase up to 80% over fixed solar with optimal panel azimuth and orientations throughout the day.

Stacking solar panels vertically will create some shading from one solar panel onto the next when extended (FIG. 1) during the midday sun. However, with longer days, the solar panels have more time to make up for the shading by tracking the sun from early morning through the evening. Shading will vary based on the latitude and longitude of the installation, time of day and time of year. For example, in summer months, the sun is much higher in the sky, and there is an average of 50% shading between 10 am and 2 pm, but the solar panels create power during midmorning and late afternoon sun offsetting this power loss. In winter months, the sun is a lot lower in the sky requiring the solar panels to be more vertical, avoiding shading from one solar panel to the next. Snow accumulation and dust is also minimized and/or avoided with solar panels in this configuration.

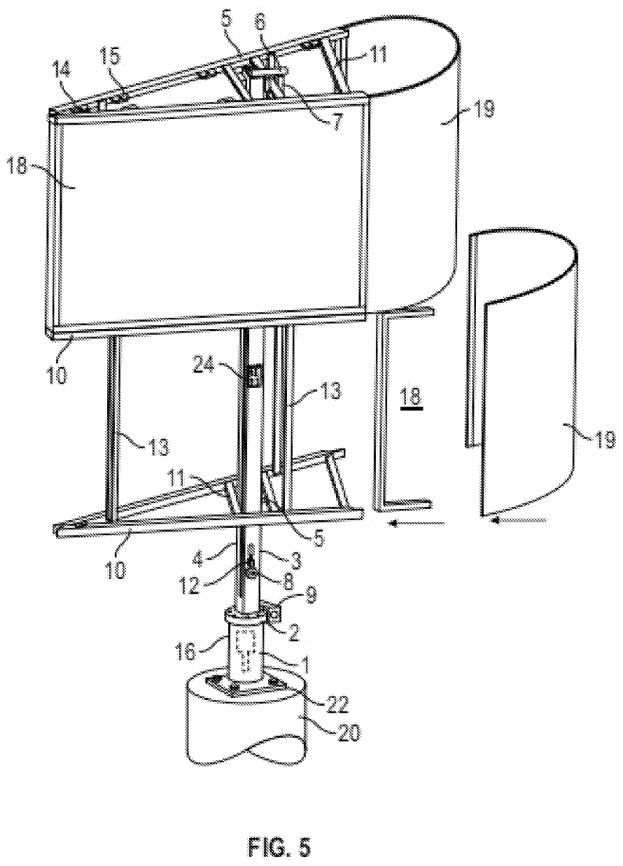

In an embodiment shown in FIG. 2, a support pedestal 1 is secured to a concrete foundation 20 (FIG. 5) with a tilt-up base flange 22. A bearing 2 is attached between the support pedestal 1 and the vertical support tube 3. As shown in FIG. 5, multiple support tubes 3 can be attached together with splice plates 24. An anemometer 25 may be mounted to the top of the airfoil with a compass 32 to control the azimuth adjustment motor 9.

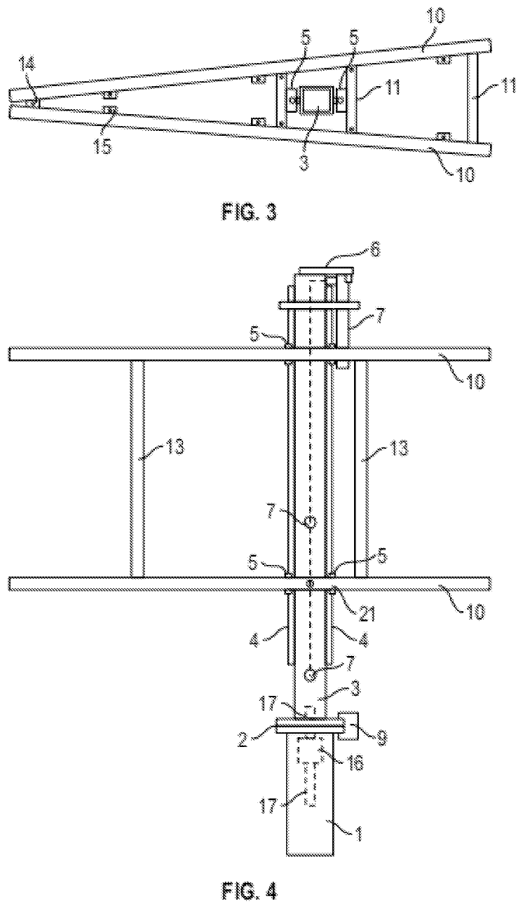

As shown in FIG. 3, channels 10 may be connected together with vertical support braces 13 (FIG. 4) to create a single frame 104. A pinned flange connection 14 and inner support braces 11 may be used to connect individual frames together to create a solar frame assembly 106. Linear motion guide blocks 5 may be attached between inner support braces 11 and the linear motion guide rails 4.

As shown in FIG. 5, solar panels 18 may be slid into the channels 10 and a front cover 19 attached to the solar frame. A load line 7 (FIG. 4) may be attached to the inner support brace 11, the topping lift 6, through the jam cleat 12 and to the winch 8 to lift the solar frames 104 vertically up the support tube 3.

Additional solar frames with solar panels 18, front covers 19 and linear motion guide blocks 5 may be connected to each other with connection flanges 15 and to the linear motion guide rails 4. A number of the solar frames 104 may be attached vertically to form two solar frame assemblies 106, one connected to each end of the nose 102 to form the airfoil 108.

A base pin 21 is used to hold all the solar frames vertically in place. Electrical wire 17 (FIG. 4) is connected to each solar panel 18 either in parallel or series and installed down through the vertical support tube 3 to a slip ring 16 and to an external solar inverter. A slip ring 16 is an electromechanical device that allows the transmission of power and electrical signals from the rotating airfoil structure to the stationary support pedestal.

Programmable LED lights (not shown) may be installed up the inside of the airfoil along the trailing edge and programmed to show the current power production or overall power produced at the end of each day.

A tilt-up base flange 22 allows the mast components to be installed at ground elevation. To assemble the solar tower installation 100, the bearing 2, support tube(s) 3, splice plates 24, linear motion guide rails 4, topping lift 6, load line 7 and slip ring 16 are all assembled together and then raised and secured in their vertical position on the support pedestal 1. In this case, the first solar frame 18 with internal bracing is assembled around the base of the vertical support tube 3. Linear motion guide blocks 5 are attached to the inner bracing 11 and linear motion guide rails 4 allowing the solar frame to move freely up and down the vertical support tube 3. The load line 7 is attached to the inner bracing 11 to hold the solar frame assembly in place while solar panels are inserted and fixed to the guide channels on each face of the solar frame assembly and a front cover installed, creating the airfoil skin.

The solar frame is raised vertically with the load line 7 by winch and a second solar frame is installed around the vertical support tube 3 and connected to the bottom of the first solar frame 104. A second set of linear motion guide blocks 5 are attached between the inner bracing 11 and linear motion guide rails 4, a second set of solar panels installed and wired together and a second front cover installed. Additional solar frames 104 are installed using the same method until the desired structure height and solar power output is achieved.

The bearing 2 allows the airfoil structure to spin freely into the wind while the support pedestal 1 remains fixed in place. A motor on the slewing bearing with the anemometer 25 and compass 22 are able to further assist in solar power generation by rotating the airfoil with the sun during periods of light wind conditions.

The support pedestal 1, vertical support tubes 3, and solar frame 104 can all be made out of lightweight materials such as aluminum or fiberglass for ease of shipping and handling and installation. The vertical support tube 3 can be made in predefined lengths and spliced together matching a set quantity of solar frames per section. Example: a 50 ft. airfoil structure could have a 3 ft. base pedestal, a 7 ft. vertical support tube and 4 (four) 10 ft. vertical support tubes with 3 solar frames per section for a total of 12 (twelve) solar frames stacked vertically.

The solar frame 104 can accommodate multiple standard “rigid” solar panels 18 such as those used for residential or commercial applications or custom designed flexible solar panels creating the skin of the airfoil. In an embodiment, SunPower 5th generation solar panels may be used. The solar panels are made of shingles, increasing solar efficiency and output per square foot with a 3×6 electrical grid pattern offering high performance during shading ( 1/18th shade increments). The solar panels may be, for example, 450 w, 535 w and 625 w in size and can be installed horizontally or vertically to the solar frames based on system design. However, the solar frames 104 may be designed to accommodate any solar panel.

The chord length of the airfoil should be a minimum of 4 times its' diameter to achieve a drag coefficient (CO less than 0.25. Example: a front diameter of 2 ft. will require a minimum chord length of 8 ft, providing a surface area of approximately 6 ft. for solar panels on each of the two faces of the airfoil.

The front cover of the airfoil can be made of any lightweight material such as rolled or bent aluminum, fiberglass or flexible solar panels with sufficient strength to maintain its airfoil shape in strong wind conditions.

In an embodiment, with the use of a crane, the entire airfoil structure with solar panels can be assembled on the ground and lifted into place, eliminating the need for a tilt-up base flange 22, vertical support tube 3, linear motion guide rails 4, linear motion guide blocks 5, topping lift 6 and load line 7.

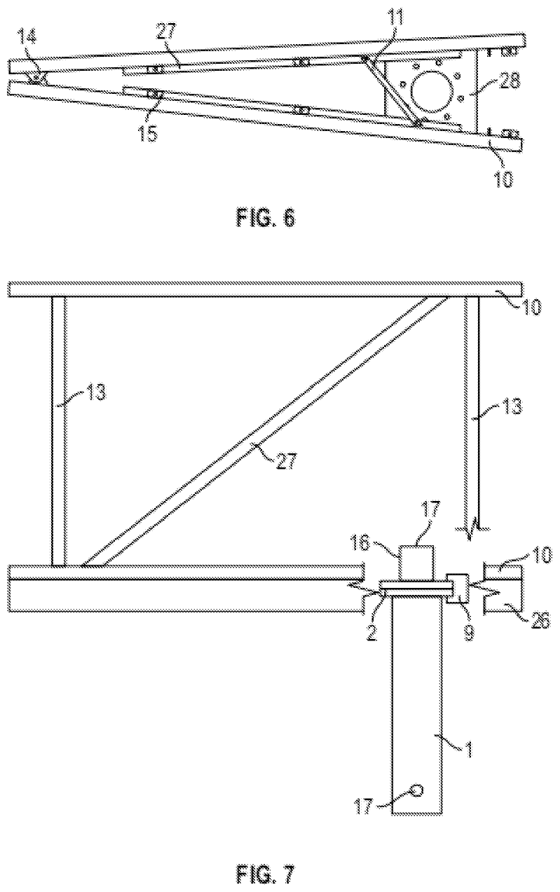

A base support plate 28 and base support frame 26 as outlined in FIGS. 6 to 8 would need to be added to transfer the axial and overturning moments of the airfoil structure through the bearing to the support pedestal 1. As shown in FIG. 6, the base support plate 28 includes a hole to accommodate a spline. In an embodiment, the spline has a 4.5″ OD (outer diameter), which may be fixed against rotation, and may be provided for electrical runs and supporting antennas, racks and batteries. The user may open the shell to climb up the inside and install equipment on the fixed spline.

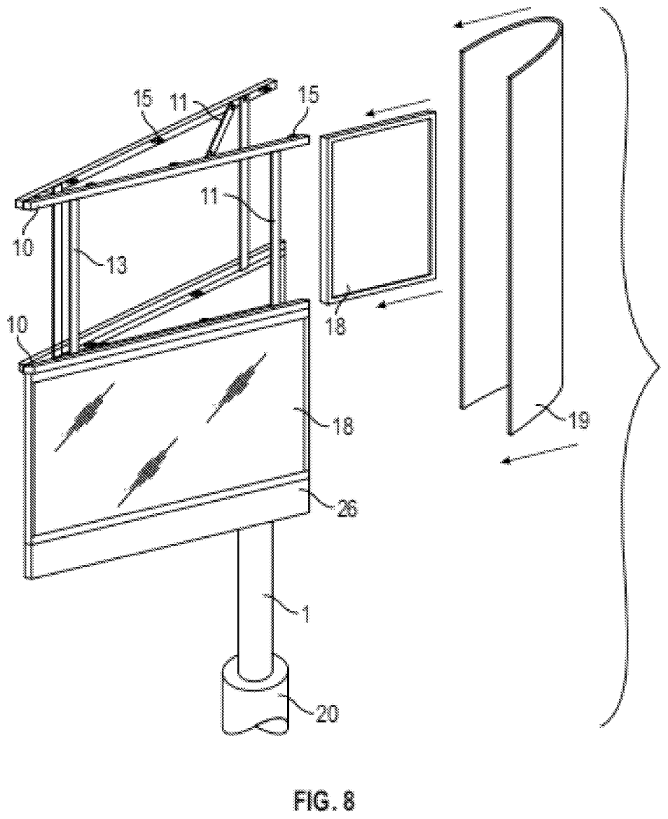

As shown in FIGS. 6 and 7, a diagonal support 27 may be included with the horizontal channels 10 and vertical support braces 13 to create the frame. FIG. 8 shows the assembly of the solar frames 104, with the solar panel 18 slid into the frame, and the front cover 19 to a number of the solar frames.

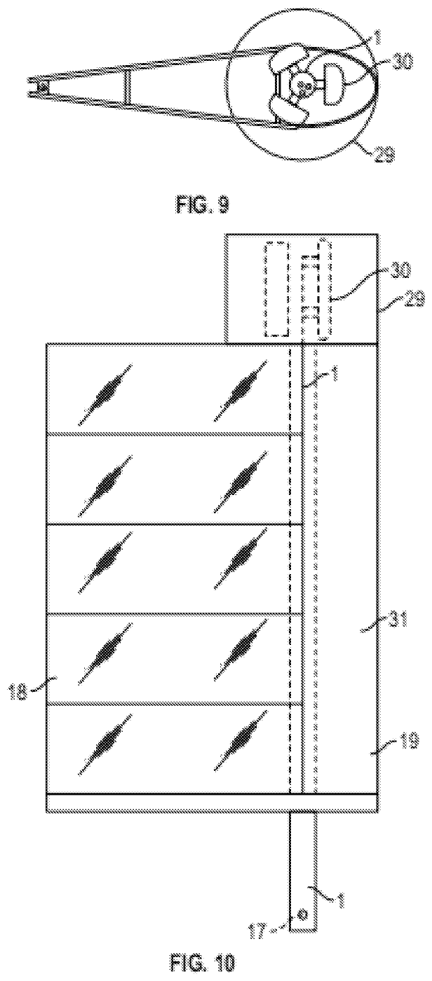

A fixed pedestal 1 spanning the entire height of the airfoil structure would allow cellular panels 30 to be installed within the airfoil or above the airfoil in an RF transparent fiberglass shroud 29 as shown in FIG. 9.

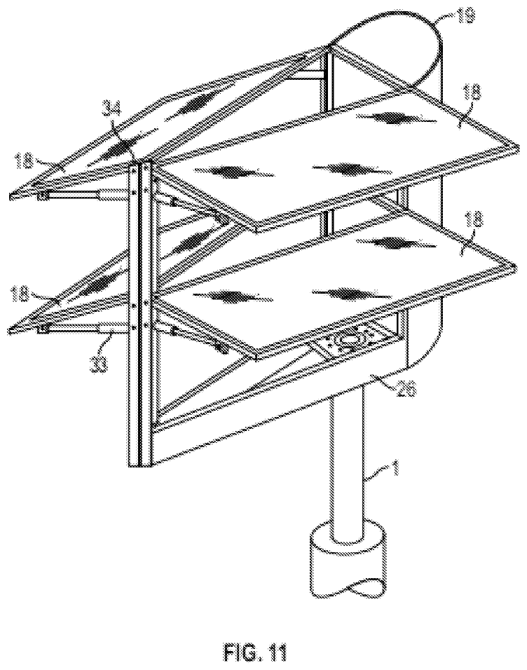

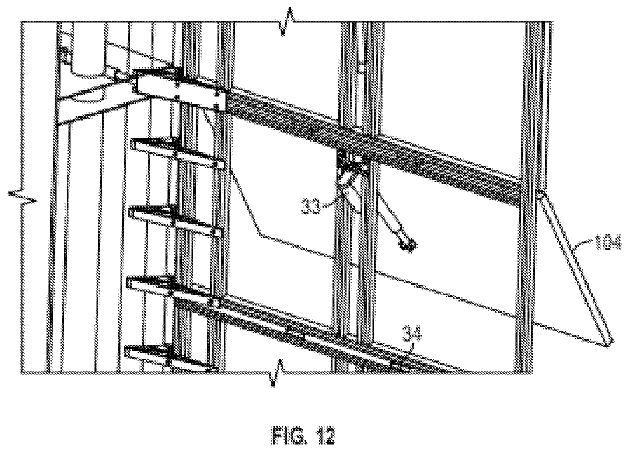

As shown in FIG. 10, marketing marks and images 31 could be incorporated on the airfoil making this attractive for restaurants, gas stations, EV charge stations, cellular carriers and other businesses for advertising or additional revenue generation purposes. The LED light track and solar power cable may be positioned along the side and through the shell.

FIG. 10 shows the solar panels in a “closed” position. The solar panels may be rotated horizontally from the closed position by up to 90 degrees in order to improve solar exposure, as shown in FIG. 11. To further increase solar power generation, each solar panel could be installed with hinges 34 and linear actuators 33 to adjust the angle of the solar panel from 90 degrees vertical to the optimal angle with the sun throughout the day. This would provide the solar panels with 2 axes of rotation with the sun: azimuth tilt.

FIG. 12 shows another embodiment of the hinges 34 and linear actuators 33. In an embodiment, the linear actuators 33, and 35 (FIG. 14) may be IP66 rated 24V DC with Hall sensors for accurate positioning. The linear actuators 33, 35 may be connected to load sensors to measure the load on the solar panels 18 and solar frame assemblies 106 due to wind forces. If the load exceeds a certain threshold, the linear actuators may close the solar frames 104 into the airfoil configuration to prevent damage to the solar panels or other components of the tower.

To use this embodiment, one would simply integrate solar panels in the skin of a vertical airfoil capable of rotating freely into the wind. The airfoil shape allows for a large number of solar panels to be installed along the chord length as well as vertically producing a large amount of solar power in a small footprint of land. The efficient airfoil shape allows for a light support structure and foundation, reducing the overall cost per kilowatt hour while providing a lot more options for installing a solar project.

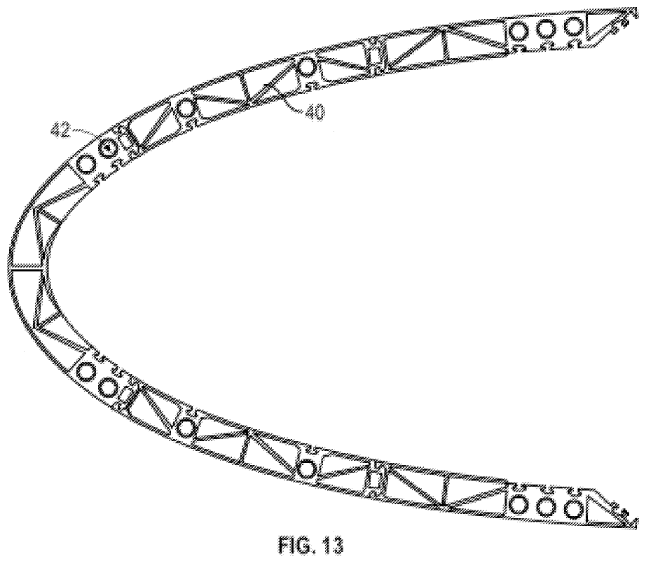

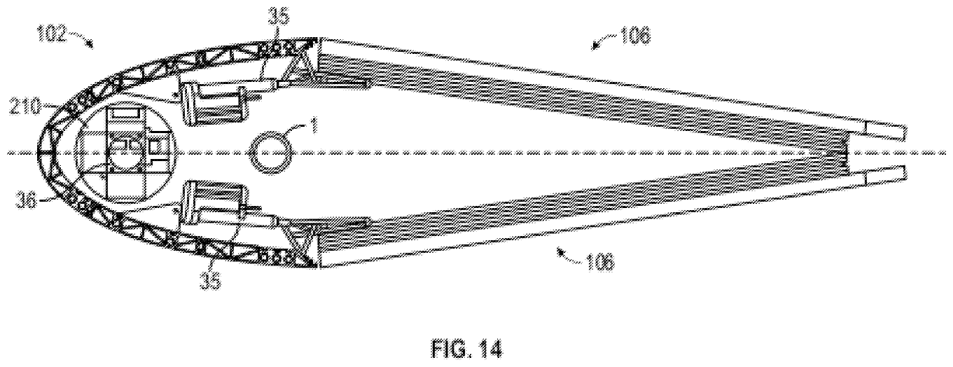

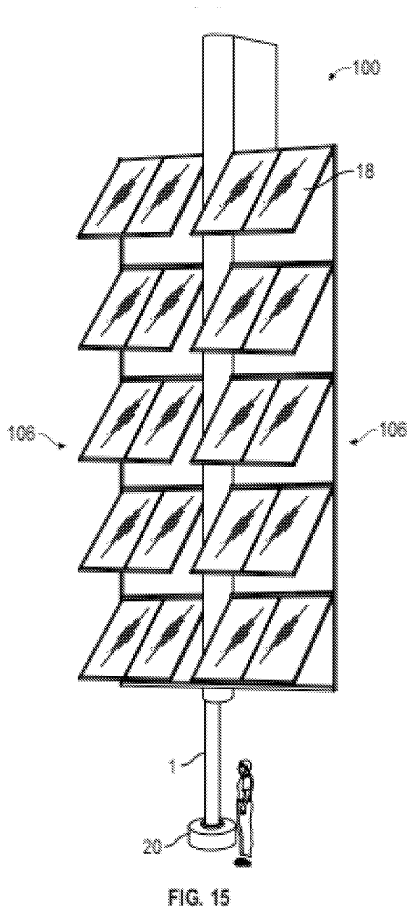

In an embodiment, the shell material for the nose 102 may have a diamond webbing structure 40, e.g., 55 mm wide by 2 mm thick with 2 mm thick inner and outer shells, to provide stress distribution throughout the shell, as shown in FIG. 13. More bolt holes 42 may be positioned in areas, for example, the nose (e.g., two on each side) and ends of the shell (e.g., three on each side). In another embodiment, the shell material may be fiberglass. Areas of the shell that experience higher stress, for example the front nose, may include additional layers of fiberglass to reinforce those areas. For example, the thickness of the fiberglass may range from ¼ inch thick in less stressed areas to one inch thick in higher stress areas.

As shown in FIG. 14, the two solar frame assemblies 106 may be attached on either end of the shell 102. Linear actuators 35 (described above) may be provided between the shell 102 and solar frame assemblies, enabling the solar frame assembles 106 to be extended, as shown in FIG. 15.

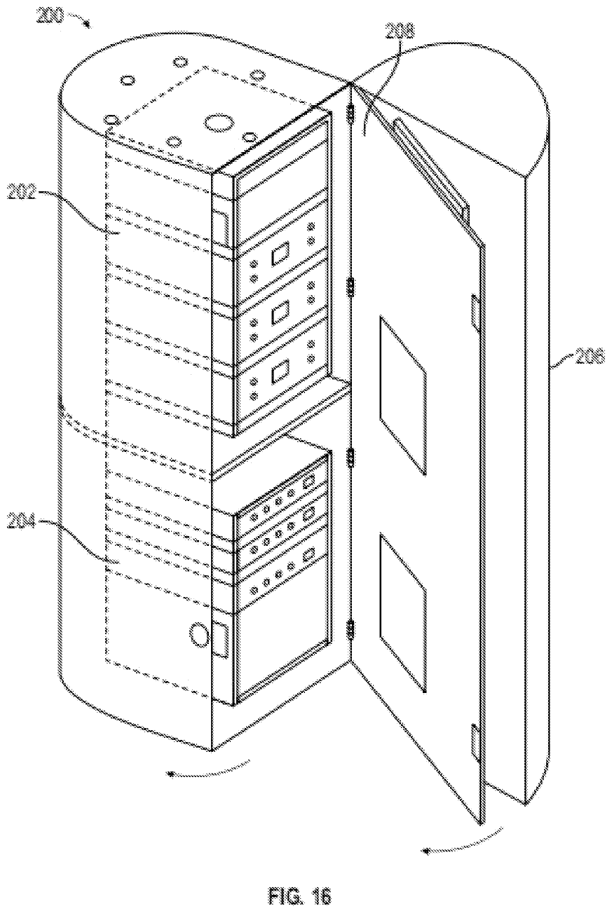

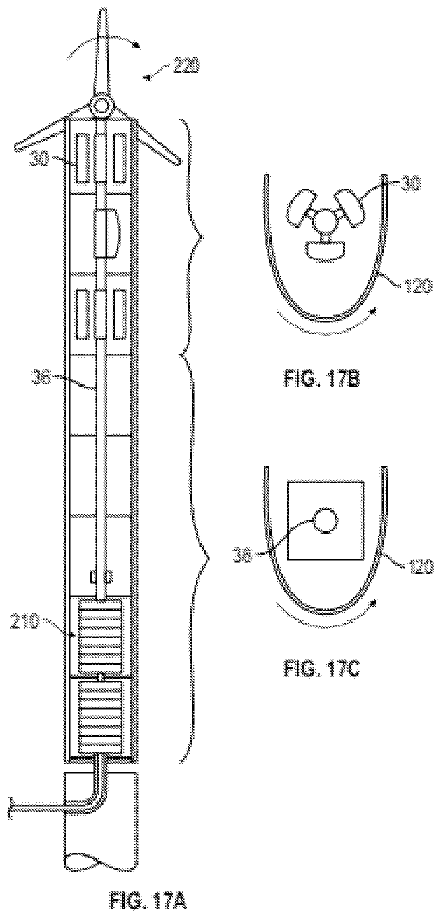

In an embodiment shown in FIG. 16, a base cabinet 200 to which the airfoil connects and rotates above, may include components such as batteries 202 and cellular equipment and tower monitoring equipment 204. A first door 206 may open to provide access to a ladder for climbing inside the airfoil and one or more LCD monitors for providing information regarding, e.g., battery conditions, wind, power, performance and errors. A second door 208 may be provided to access the batteries.

The base cabinet 200 may be designed to fit a standard 19.5″ racking system. The base cabinet may be fully enclosed with grounding, air conditioning, fans, and temperature control.

The batteries 202 may be lithium power racks. The batteries may be, e.g, 2.5 kW, 5 kW, or 10 k stackable battery packs. The batteries may be connected in series or parallel, depending on the application. A battery management system (BMS) control unit may be provided for each lithium power rack to control and monitor, e.g., voltage and cell temperature, power supplied by the system, load control, etc.

As shown in FIG. 17A, round lithium power discs 210 may be placed in the nose 102 for additional space saving (see also FIG. 14). The lithium power discs may be 5 kW 51.2V discs (18″×6″×50 lbs) that can be stacked in parallel or series to increase to a 308V system for 2-way electrical vehicle charging. In this manner, the tower 100 can be used to charge an electrical vehicle when the batteries have sufficient charge, and the batteries in the electrical vehicle may be used to charge the batteries in the tower if the tower batteries run low.

FIGS. 17B and 17C show how the nose can rotate around components in the tower connected around the non-rotating spline 36.

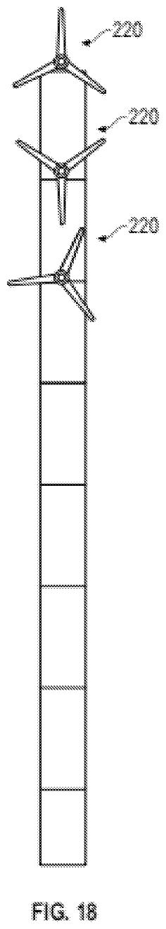

In an embodiment shown in FIG. 18, stacked horizontal axis wind turbines 220 may be attached to the shell above the solar panel section of the tower with a bearing to allow the turbine section to rotate independently of the solar section. Motors for the wind turbines may be provided within the shell.

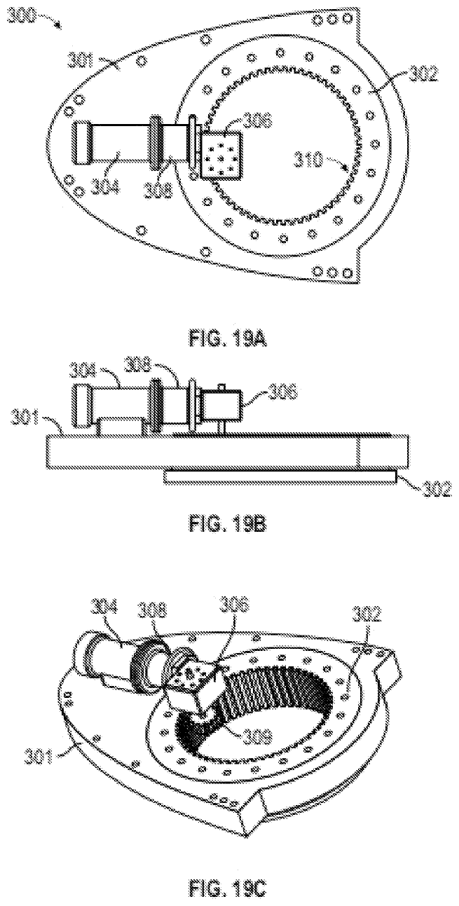

FIGS. 19A to 19C show different views of a base design including a slewing bearing assembly 300 for the tower 100. The extruded aluminum or fiberglass shell bolts to a forged outer bearing 301. Inner bearing 302 is bolted to the concrete foundation. A motor 304 drives a gear reducer 306 through an electromagnetic clutch and break unit 308 at a desired gearing ratio between the pinion 309 on the reducer 306 and the teeth 310 on the inner diameter of the inner bearing 302. This allows the structure to rotate 360 degrees and brake in an appropriate position based on predicted and/or measured weather conditions. In high wind conditions, the clutch may be released, allowing the airfoil structure to rotate freely.

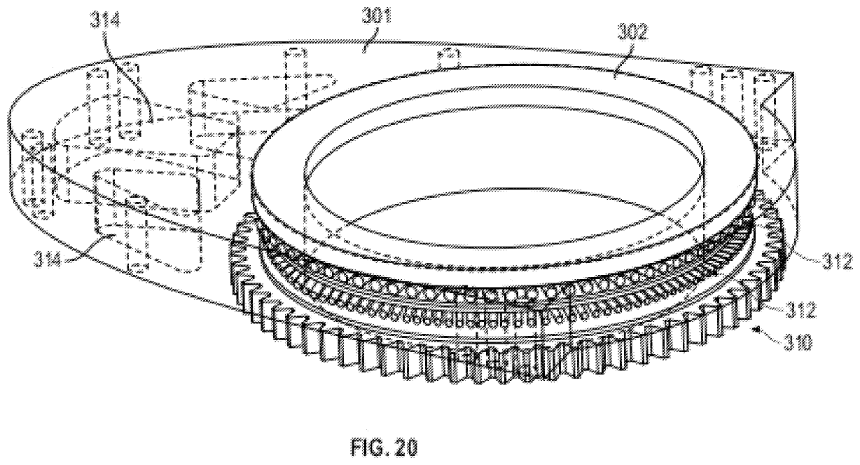

FIG. 20 shows another embodiment with gear teeth 310 on the outer diameter of the inner bearing 302 and the internal bearings 312 in the bearing. Portions 314 may be cut out of the forged outer bearing 301 to reduce weight.

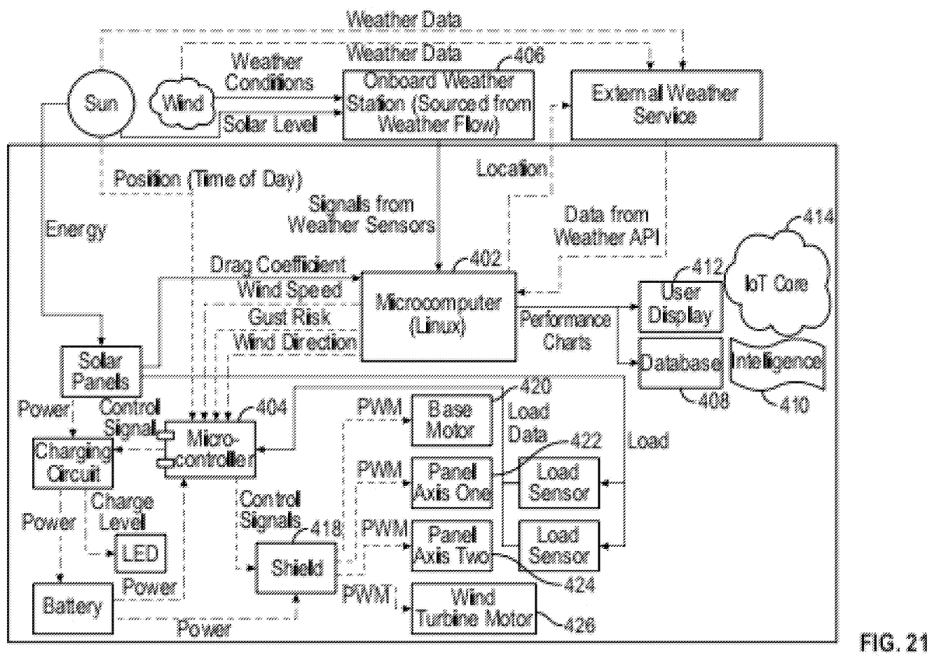

The airfoil solar tower structure may be controlled by a control unit. FIG. 21 is a schematic of the control unit, which may include a microcomputer 402 and microcontroller 404, and how the control unit interacts with other components of the system. The tower 100 may include an all-in-one weather monitoring system 406 to obtain wind speed and direction, ambient light, ultraviolet index, solar radiation, temperature and humidity, and a lightning sensor (strikes & distance). This information can be provided to the microcomputer 402, as well as be used to safely operate and climb the tower. An example of such a weather monitoring system is provided by the company WeatherFlow. This device also links with an external weather service, such as the National Oceanic and Atmospheric Administration (NOAA), which provides its own forecast models. The microcomputer 402 can use this information along with past climate and power usage information in a database 408 and internal intelligence 410 to provide predictive analysis of future power production versus usage, and provide notifications if power is anticipated to be limited. A user may access this and other information through a user display and interface 412, or remotely through cloud computing web service/Internet of things (IoT) module 414.

Based on current and predictive solar and weather conditions, the microcomputer 402 can send signals to microcontroller 404 to move and orient the solar panels and wind turbine to respective positions in order to take advantage of the solar and weather conditions. The microcontroller 404 may send control signals through a shield 418, to control each motors “throttle” and direction to a base motor 420, panel axis 1 motor 422, panel axis 2 motor 424, and wind turbine motor 426. The base motor 420 may rotate the entire structure 360 degrees to an appropriate position. The panel axis 1 motor 422 may control the degree of tilt of the solar panels. The panel axis 2 motor 424 may control the opening of the solar frame assemblies from ends of the shell 102 from a closed, airfoil configuration, as shown in FIG. 14, to an open position, as shown in FIG. 15. The wind turbine motor 426 may rotate the wind turbine into the wind.

Load data may also be provided to the microcontroller 404 from the load sensors on the linear actuators for the solar panels and solar frame assemblies. Based on this load information, the microcontroller 404 may close the solar panels and solar frame assemblies into the airfoil configuration, and may release the clutch to enable the structure to freely rotate.

In an alternative embodiment, the airfoil solar tower structure could also be incorporated into the design of a fixed wing sail for sailboats. To keep the structure lightweight, the skin would be made with flexible solar panels with an internal flexible frame such as carbon, allowing the windward face to flex inward, improving lift. A bearing could still be incorporated into the mast with an azimuth adjustment motor to control the angle of the fixed wing in relation to the wind.

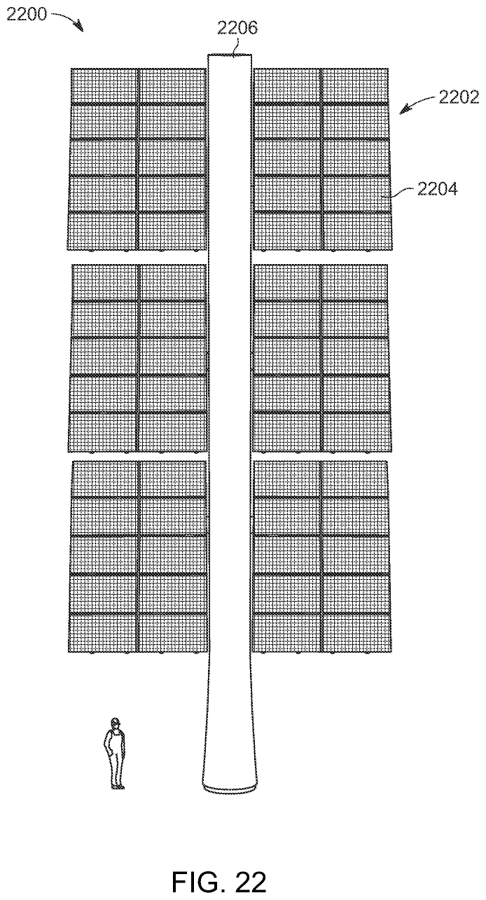

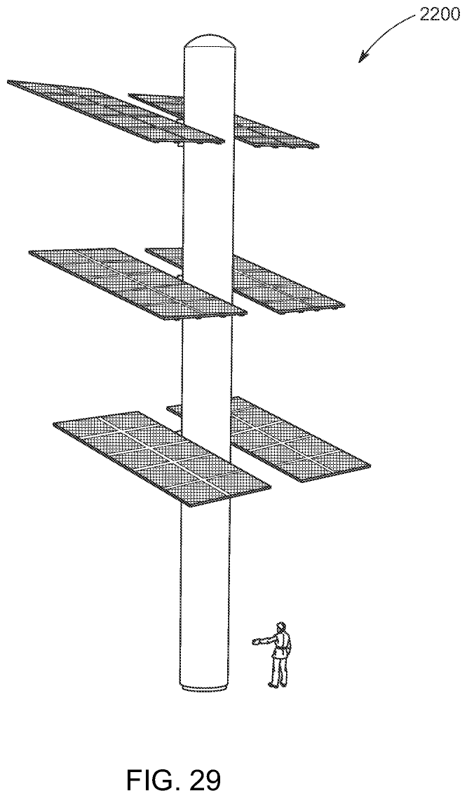

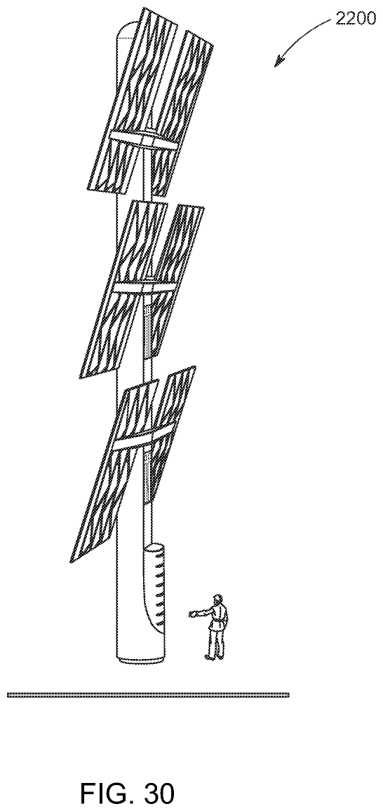

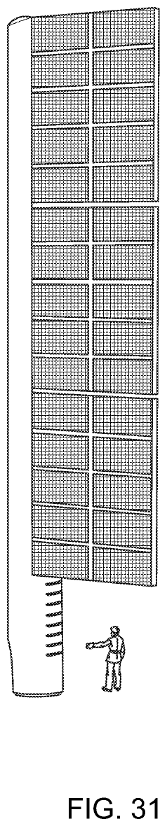

In another embodiment shown in FIGS. 22-31, a solar tracking tower 2200, also referred to as the “tower”, “tower structure”, and “solar tower”, includes assemblies 2202 of adjacent and electrically connected solar panels 2204, also referred to as “wings” 2202. Pairs of wings, or “wing sets”, may be connected at a same height on the tower. This configuration enables the different sets of wings to be moved between the open and closed positions independently, as opposed to being moved as an entire structure. This may reduce the overall power and force required to move the solar panels. This configuration also rotates all of the solar panels on a wing together as one piece as opposed to rotating each individual solar panel with an individual linear actuator. This may require less linear actuators and may reduce the overall weight, equipment cost, and complexity of the system.

The solar panels 2204 on each wing may be electrically connected in series to form a string. A power optimizer may be connected to each solar panel to maximize power output even under shade conditions. The power optimizer may attempt to optimize the system, using, for example, maximum power point tracking (MPPT), when the load characteristic changes to keep power transfer at the highest efficiency even when conditions are not ideal by adjusting the load characteristic as the conditions change.

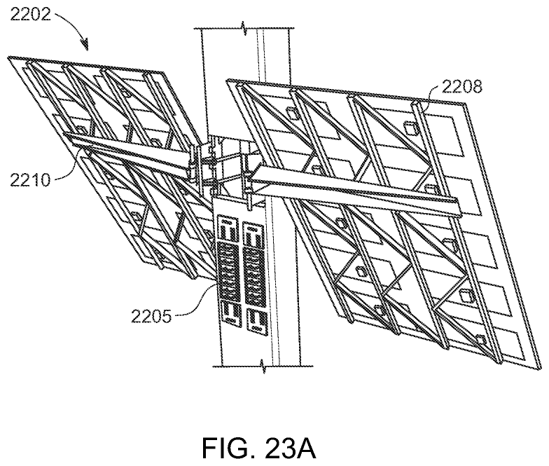

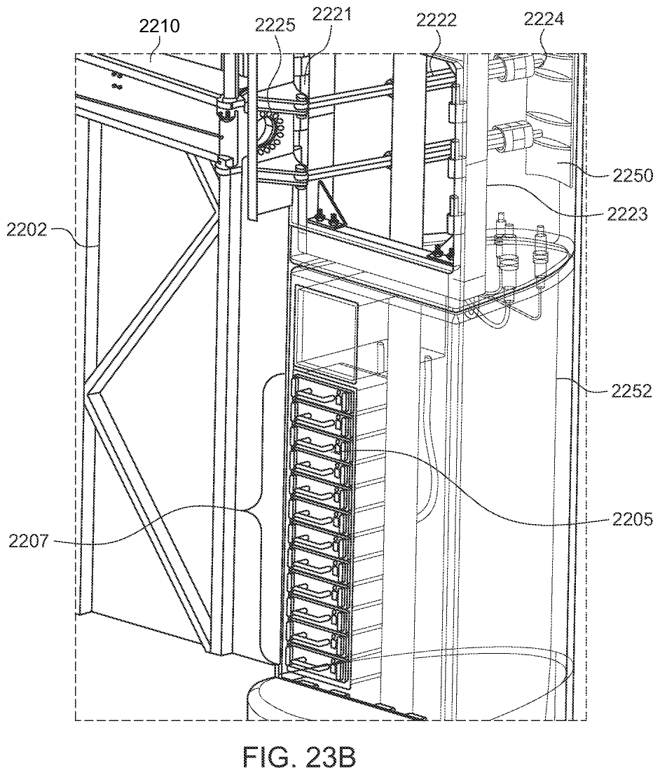

Each battery pack 2205, or string, may also be tied in series or parallel to create a storage battery bank 2207 (FIG. 23B). Each string of batteries may be tied to an inverter. The inverter may manage charging and discharging of the battery as well as other features, such as monitoring and fault reporting, allowing the system to track performance and identify or predict problems.

In an embodiment, each wing may include ten solar panels. In an embodiment, the type of solar panel used may have a nominal power output of 500 W. With three wing sets (sixty panels), the tower may provide a total of 30,000 kWh of solar energy.

Each wing may include a battery bank with ten battery packs (one per solar panel) connected in series, and the six battery banks may be connected in parallel.

Each wing 2202 may be attached to a frame 2223 in a shell 2206 by an arm 2210, as shown in FIG. 23B. The shell 2206 may be manufactured using a fiber reinforced plastic (FRP) process, for example, a filament winding process in which a continuous strand of fiber is impregnated with resin and then wound around a rotating mandrel. Various materials may be selected from for the fiber, e.g., glass, carbon, aramid, basalt, etc., and for the resin, e.g., polyester, vinyl ester, and/or epoxy. The particular types of materials and the number of layers spun to form the shell may be selected based on the desired weight and structural integrity of the structure.

The wings 2202 may include a frame assembly 2208 which may be connected to a corresponding arm 2210.

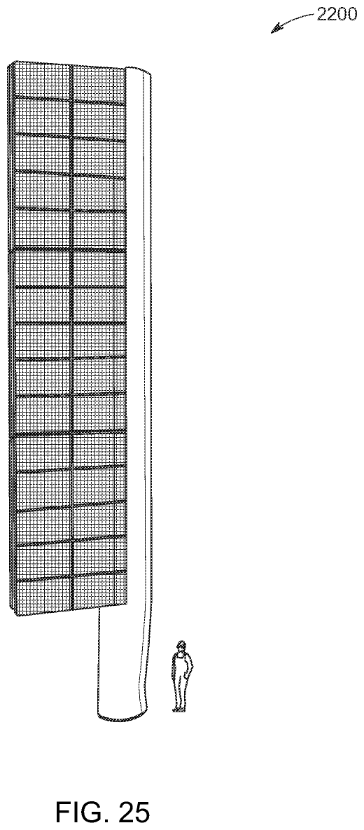

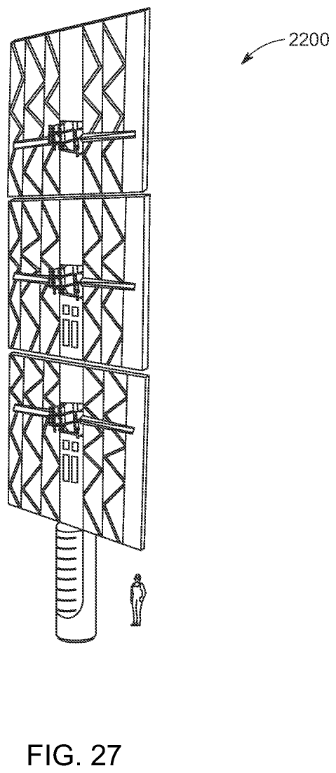

As shown in FIG. 23B, arm 2210 may be connected to the tower 2200 via a linear actuator 2222 and a slewing drive 2225. The linear actuator 2222 may move the arm, and connected wing, along a horizontal axis from a closed, or folded, position (FIG. 25) to an open, or “barn door”, position (FIG. 27). The linear actuator 2222 may be, for example, a 40 kiloNewton (KN) linear actuator with a brushed DC motor. The linear actuator may be connected at its base (proximal end) to a plate 2250 on the interior of the nose 2252 of the shell 2206 and at its other, distal end to a hinge 2221 which in turn connects to the wing 2202. A load pin 2224 may be connected at the end between linear actuator 2222 and the plate 2250 to measure the force on the wings from the wind.

A slewing drive 2225, for example, an SC9 slewing drive with a brushless DC (BLDC) motor, may rotate the arm and connected wing to better track the sunlight, as shown in FIGS. 25-30. In an embodiment, the slewing drive may rotate the wing up to 90° (horizontal), but potentially up to 360°.

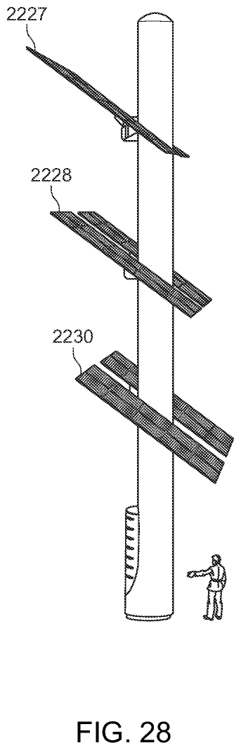

The arms 2210 may be positioned at different locations on the different wing sets. For example, as shown in FIG. 28, the arms of the top wing set 2227 may be connected on a lower portion of the wings, the arms of the center wing set 2228 may be connected at about the center of the wings, and the arms of the bottom wing set 2230 may be connected on an upper portion of the wings. This offset may reduce shading caused by upper wing set(s) on lower wing sets when the wings are rotated, thereby increasing the available solar panel surface area to receive direct sunlight.

In an exemplary embodiment, the tower 2200 may include three wing sets and have an overall height of 63 feet and overall width of 28 feet. The base may have a diameter of 5 feet and height of 11.5 feet. Each wing set may have a height of 17.2 feet and a width of 28 feet.

The wing set sections of the tower may be modular such that more, or less, wing sets may be provided on the tower based on the user's power needs. In an embodiment, each module includes one or more connectors for mechanical, electrical, communication, etc., connections between the module and an upper and/or lower module or the base.

The tower 2200 may share many of the same structures, systems, and functions as the embodiments of the tower 100 described above. For example, a base 2212 of the tower 2200 may include a base gear design including a slewing bearing assembly enabling the tower 2200 to be fixed against rotation (brake engaged), rotated by a motor into a desired position, or allowed to rotate freely, for example, in high wind conditions, as described in connection with FIGS. 19A-C above.

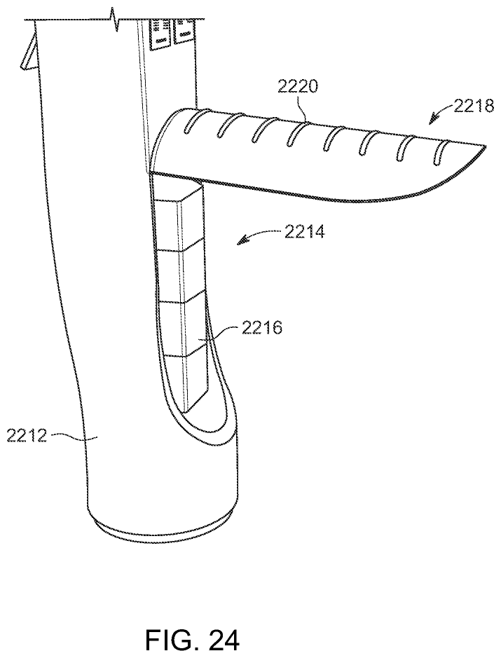

As shown in FIG. 24, a base cabinet 2214 at the base of the tower 2200 may include various equipment 2216 including, for example, a server, user interface, batteries, and other equipment. In an embodiment, the equipment and/or battery storage can be supported within the base on a server rack, e.g., a 42 U server rack. Other equipment may also be installed in the shell 2206 at different heights on the tower.

The tower 2200 may include a wireless network interface and communication equipment to enable the tower 2200 to act as a base station in a wireless telecommunication network. The network capabilities may also provide users the ability to control and monitor various systems in the tower 2200 via a remote user computer or smart device. Monitoring and control systems may also be provided in the base cabinet 2214.

An access panel 2218 may include rungs 2220 for accessing higher portions of the tower. Ladder-structures and steps are also contemplated. In an embodiment, the tower may prepare for a user to climb it by rotating into the wind, opening wing sets, completing a weather check, and when safe, deploying steps for climbing.

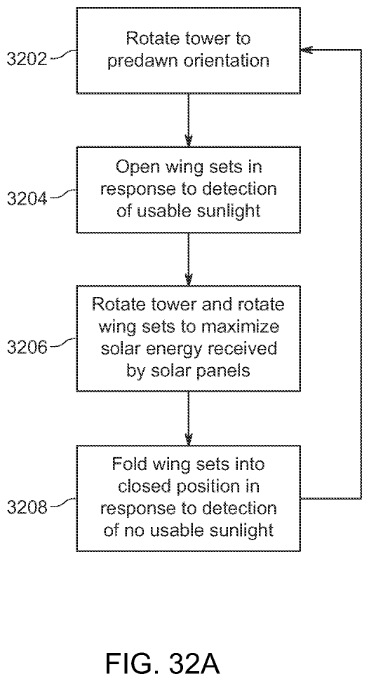

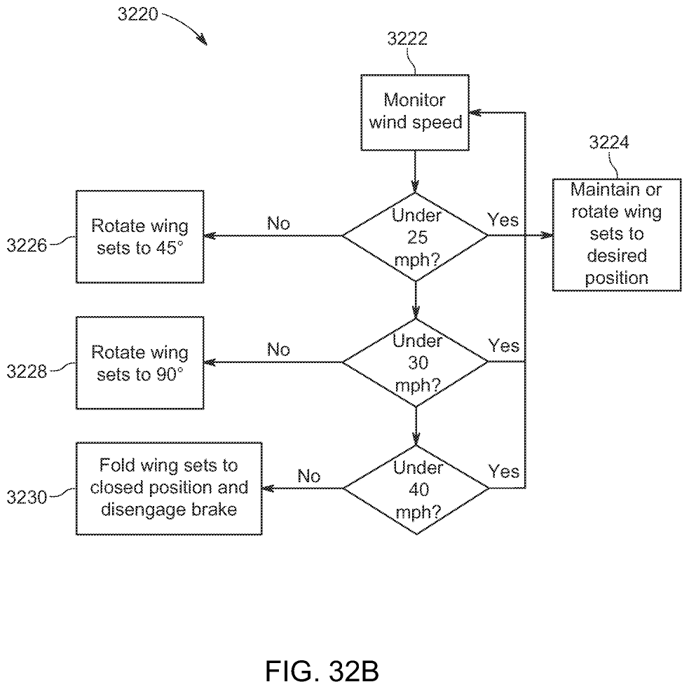

FIGS. 25 to 31 show the tower 2200 in different orientations, e.g., the direction the nose of the shell is facing, and wing configurations during an exemplary daily solar tracking operation 3200 according to an embodiment, shown in FIG. 32A. FIG. 25 shows the tower in a predawn position prior to sensing any usable sunlight. The tower 2200 is in a closed position with all wing sets folded in. The tower 2200 may be rotated into a predawn orientation (block 3202) to capture the first usable sunlight, which may be based on the prior day's predawn orientation, predictions based on historical data in a database, known position of the sun based on the time and location of the solar tower, and/or information received from the weather monitoring system and external weather service.

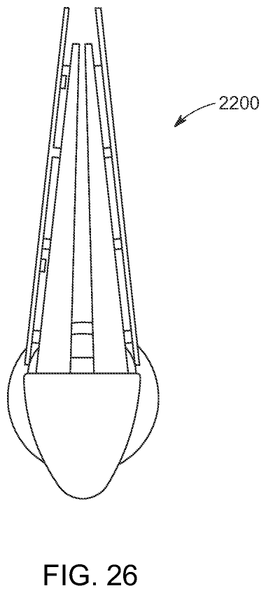

FIG. 26 is a top-down view of the shell and wing sets in the closed position, in which the structure forms an airfoil shape. This may also be the shape the tower returns to in extreme weather conditions, such as extremely high wind speeds where the solar tower can rotate freely with the wind.

When the weather monitoring system, which includes a solar tracking system, determines there is sufficient sunlight, the wing sets may be fully opened into the barn door position, as shown in FIG. 27 (block 3204).

As shown in FIGS. 28-30, as the position of the sun moves throughout the day, the control unit may rotate the tower and the angles of the wing sets to maximize the amount of solar energy received by the solar panels (block 3206). When the solar tracking system determines there is no more usable sunlight, the wing sets may be folded into the closed position (block 3208). The tower may then be rotated back to a predetermined predawn orientation for the next day at some point during the night.

In an embodiment, the control unit may change the position of the wing sets based on wind speed to ensure structural stability and integrity of the tower structure. FIG. 32B shows a wind speed monitoring and control operation 3220 according to an embodiment. The weather monitoring system may continuously monitor the wind speed (block 3222). For wind speeds up to 25 mph, the wing sets may be in any desired position (block 3224), including fully opened in the barn door configuration shown in FIG. 27. For wind speeds over 25 mph and up to 30 mph, the wing sets may be rotated into a 45° position (block 3226), as shown in FIG. 28, to reduce the force experienced by the tower due to the force of the wind on the surface area of the wing sets. For wind speeds over 30 mph and up to 40 mph, the wing sets may be rotated into a horizontal position)(90° (block 3228). For wind speeds above 40 mph, the wing sets may be folded into the closed position elevation by elevation to minimize loads on the structure and the brake released (block 3230), allowing the airfoil structure to rotate into the wind for the least amount of drag. Although specific thresholds for an exemplary embodiment have been described, the thresholds may differ based on the structural factors inherent in different designs, user confidence, regulations, required power needed to be generated, and other factors.

In alternative embodiments, various additional equipment may be provided in the tower to provide additional functionality.

Cellular equipment may be incorporated into the tower 2200 to provide networking capabilities. Wireless communication equipment may be incorporated into the server rack 2216, and antennas incorporated in the shell structure at a variety of heights in the tower. The top of the tower may be extended above the top wing set to accommodate antenna(s) as well.

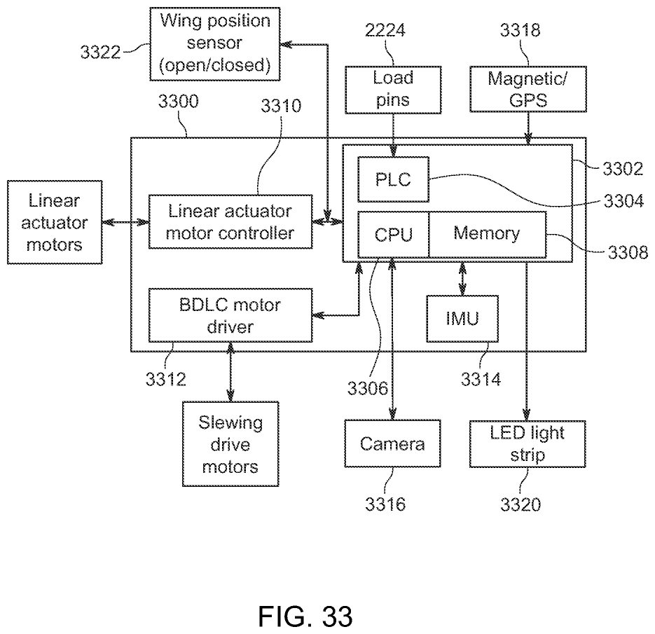

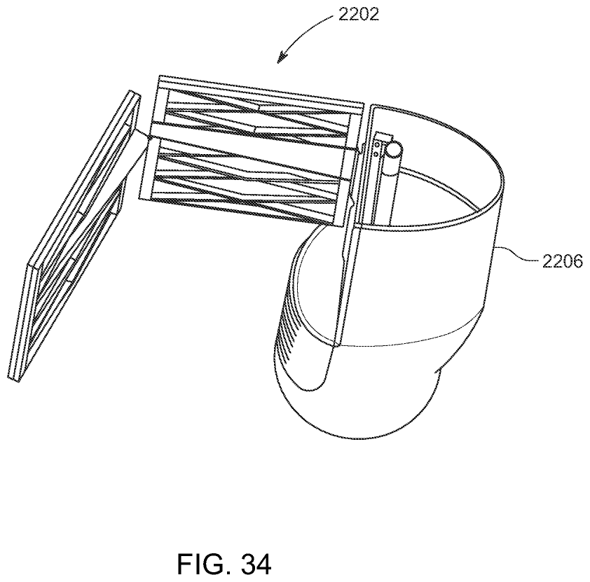

FIG. 33 shows an equipment control module 3300 which may be included in the control unit described in connection with FIG. 21. The control module 3300 may include a controller 3302. The controller may include a programmable logic controller (PLC) 3304, for example, the Arduino Opta, and central processing unit(s) (CPU(s)) 3306 with associated memory 3308.

The linear actuators 2222 may be controlled by a linear actuator motor controller 3310 via a controller area network (CAN) bus and analog signals. The linear actuator motor controller 3310 may send commands to the linear actuators based on instructions from the controller 3302, as well as receive speed, torque, position, over/under current temperature, and Hall sensor information from the linear actuators.

The slewing drives 2225 may be controlled by a BDLC motor driver 3312 via a CAN bus. The BDLC motor driver 3312 may send commands to the slewing drivers based on instructions from the controller 3302, as well as receive speed, torque, position, over/under current temperature, and Hall/encoder sensor information from the slewing drivers.

The load pins 2224 may send signals directly to the PLC 3304 to monitor loads on the linear actuators 2222.

Camera(s) 3316 may be positioned facing down the length of the tower and provide video and/or rapid still photo information, which may be used to confirm the position of the wing sets, as well as for security and equipment monitoring purposes. The camera(s) 3316 mounted on the tower may be night vision-equipped motion control cameras and include speakers to communicate with technicians. Also, the camera(s), which may include a lidar camera or motion camera, may be used to determine the orientation and movement of the wings.

A magnetic compass 3318 may be integrated into the tower to determine and confirm the exact orientation of the tower. Alternatively, in order to avoid potential interference with electrical and electronic components in the tower, an electrical compass may be used, or a GPS device with dual antennas provided at the top of the tower.

A continuous or segmented LED strip light 3320, e.g., a 24V IP68 RGB+W strip light, may be provided along a length of the tower as described above with respect to tower 100.

(IMU(s)) 3314, e.g., CAN-compatible 9-axis IMU(s), may be used to measure the pitch, angle, and vibration of each wing and may communicated this information to the controller 3302 to change the position of the wingsets or rotation of the tower.

The controller 3302 may receive information from the motor controller 3310, motor driver 3312, IMU(s) 3314, camera(s) 3316, load pin 2224, and magnet/GPS device 3318 to monitor the position, movement, and status of the various components and send reports to the control unit. The controller 3302 may send instructions to the motor controller 3310 and motor driver 3312 to control the movement and position of the arms based on instructions from the control unit in order to perform the various operations described above. The controller may also send instructions to the LED light strip(s) 3320 to control the display. Wing position sensors 3322 may be provided to indicate whether the wings are in the open or closed (folded) position.

In an embodiment, the wings may be hinged between panels, as shown in FIG. 34. This may facilitate assembly, disassembly, and transportation of the wing set modules.

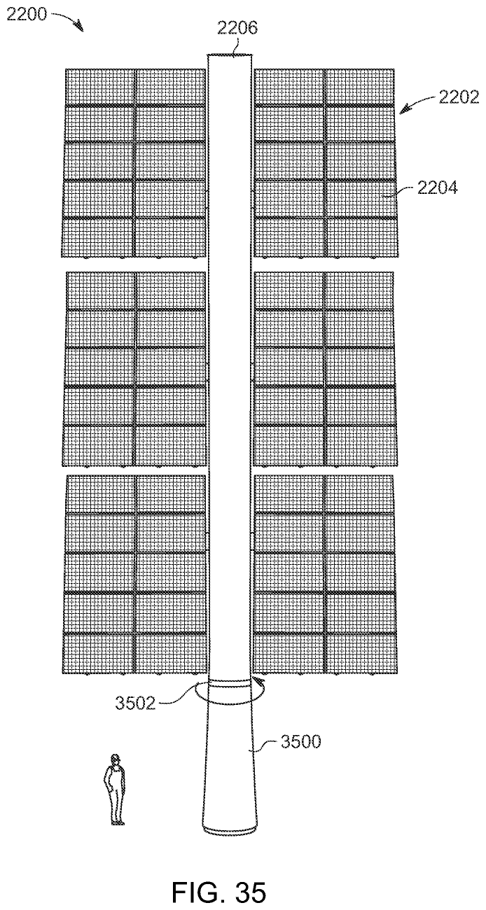

In an embodiment shown in FIG. 35, the solar tower may have a fixed base assembly 3500 at ground level approximately 12′ in height and then have a “base bearing” 3502 at 12′ elevation to rotate the upper portion of the tower including the wings. This may be useful, for example, for incorporating an EV charging station into the base, which could have charge ports for one or two vehicles, which wouldn't be practical if the base rotated. This could also make it easier to gain access to the server rack and other equipment inside the base of the tower.

In alternative embodiments, types of motors other than brushed and brushless DC motors may be used for various components, including the linear actuators and the base drive. These include, for example, servo motors, stepper motors, and stepper servo motors. For example, a stepper motor or stepper servo motor may provide precise torque based on current, and stepper or stepper servo motor(s) in the base may eliminate the need for a mechanical braking mechanism. Also, a gyro and accelerometer system may be used to monitor the amount of vibration on a wing from the wind direction and speed and in response to exceeding a threshold initiate the wing(s) to rotate, reducing the air turbulence for a more laminar flow of wind flow through the solar tower. Oscillation of the solar tower from the rapid changes in wind direction may also be monitored, one or more solar wings can be opened several degrees to change the laminar flow around the airfoil thus increasing drag to stabilize the solar tower.

The foregoing method descriptions and diagrams/figures are provided merely as illustrative examples and are not intended to require or imply that the operations of various aspects must be performed in the order presented. As will be appreciated by one of skill in the art, the order of operations in the aspects described herein may be performed in any order. Words such as “thereafter,” “then,” “next,” etc. are not intended to limit the order of the operations; such words are used to guide the reader through the description of the methods and systems described herein. Any reference to claim elements in the singular, for example, using the articles “a,” “an,” or “the” is not to be construed as limiting the element to the singular. Further, the use of directional descriptors such as “up”, “upward”, “down”, “downward”, “front”, “back”, “rear”, “top”, “upper”, “bottom”, “lower”, “left”, “right” and other such terms refer to the device as it is oriented and appears in the drawings and are used for convenience only; they are not intended to be limiting or to imply that the device has to be used or positioned in any particular orientation.

Various illustrative logical blocks, modules, components, circuits, and algorithm operations described in connection with the aspects described herein may be implemented as electronic hardware, computer software, or combinations of both. To clearly illustrate this interchangeability of hardware and software, various illustrative components, blocks, modules, circuits, operations, etc. have been described herein generally in terms of their functionality. Whether such functionality is implemented as hardware or software depends upon the particular application and design constraints imposed on the overall system. One of skill in the art may implement the described functionality in varying ways for each particular application, but such implementation decisions should not be interpreted as causing a departure from the scope of the claims.

The hardware used to implement various illustrative logics, logical blocks, modules, components, circuits, etc. described in connection with the aspects described herein may be implemented or performed with a general purpose processor, a digital signal processor (“DSP”), an application specific integrated circuit (“ASIC”), a field programmable gate array (“FPGA”) or other programmable logic device, discrete gate logic, transistor logic, discrete hardware components, or any combination thereof designed to perform the functions described herein. A general-purpose processor may be a microprocessor, a controller, a microcontroller, a state machine, etc. A processor may also be implemented as a combination of receiver smart objects, e.g., a combination of a DSP and a microprocessor, a plurality of microprocessors, one or more microprocessors in conjunction with a DSP core, or any other such like configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions (or code) on a non-transitory computer-readable storage medium or a non-transitory processor-readable storage medium. The operations of a method or algorithm disclosed herein may be embodied in a processor-executable software module or as processor-executable instructions, both of which may reside on a non-transitory computer-readable or processor-readable storage medium. Non-transitory computer-readable or processor-readable storage media may be any storage media that may be accessed by a computer or a processor (e.g., RAM, flash memory, etc.). By way of example but not limitation, such non-transitory computer-readable or processor-readable storage media may include RAM, ROM, EEPROM, NAND FLASH, NOR FLASH, M-RAM, P-RAM, R-RAM, CD-ROM, DVD, magnetic disk storage, magnetic storage smart objects, or any other medium that may be used to store program code in the form of instructions or data structures and that may be accessed by a computer. Disk as used herein may refer to magnetic or non-magnetic storage operable to store instructions or code. Disc refers to any optical disc operable to store instructions or code. Combinations of any of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed aspects is provided to enable any person skilled in the art to make, implement, or use the claims. Various modifications to these aspects will be readily apparent to those skilled in the art, and the generic principles defined herein may be applied to other aspects without departing from the scope of the claims. Thus, the present disclosure is not intended to be limited to the aspects illustrated herein but is to be accorded the widest scope consistent with the claims disclosed herein.

1. A solar tower installation comprising:
a tower structure including a curved nose portion;
a base;
a bearing assembly connected to the tower structure, and operable to enable the tower to rotate about the base;
a motor connected to the bearing assembly;
a clutch connected between the motor and the bearing assembly;
a plurality of vertically stacked solar wing assemblies, each solar wing assembly including
two solar wings, each solar wing including a plurality of connected solar panels in a frame assembly,
two arms, each arm connecting the frame assembly of one of the two corresponding frame assemblies to the tower structure via a linear actuator to control horizontal movement of said frame assembly between an open position and a closed position and a drive to control rotation of said frame assembly between a vertical position and a horizontal position, wherein in the closed position and vertical position, said solar wing assembly and curved nose portion of the tower structure form an airfoil configuration;
a solar sensor system configured to determine solar conditions at the tower structure;
a wind sensor system configured to determine wind force on each of the solar wings and wind speed at the tower structure;
a control system; and
a non-transitory memory containing instructions when executed by the control system causes the control system to perform the steps of
monitoring information from the solar sensor system and control the motor to rotate the tower, said linear actuator corresponding to each solar wing to extend between the open and closed positions, and said drives to rotate the corresponding solar wings in response to solar conditions, and
monitoring information from the wind sensor system and in response to determining that at least one of the wind speed and wind force exceed a corresponding threshold, initiating an airfoil operation including controlling the linear actuator in each frame assembly to move the frame assembly into the airfoil configuration and disengage the clutch to enable the tower structure to move freely.

2. The solar tower installation of claim 1, wherein each solar wing assembly further comprises:
one or more electrically connected batteries, and
wherein the plurality of solar panel in each frame assembly are electrically connected to each other and said one or more batteries.

3. The solar tower installation of claim 1, wherein the solar wings in one of said plurality of solar wing assemblies are physically offset from the solar wings of an adjacent solar wing assembly to reduce shading.

4. The solar tower installation of claim 1, wherein the non-transitory memory contain instructions when executed by the control system causes the control system to rotate the frame assemblies at an angle corresponding to a range of wind speeds to reduce wind force on the tower structure.

5. The solar tower installation of claim 1, wherein when the bearing assembly and the tower structure in the airfoil configuration are configured to enable the tower to rotate freely around the base in response to the direction of incoming wind and move the curved nose portion into the direction of the incoming wind.

6. The solar tower installation of claim 1, wherein the wind sensor system includes a plurality of strain gauges, each of said strain gauges connected to a corresponding one of the solar wings.

7. The solar tower installation of claim 1, further comprising a gyro and accelerometer system.

8. The solar tower installation of claim 7, wherein the gyro and accelerometer system is configured to determine a vibration on each of the solar wings, wherein the non-transitory memory further contain instructions when executed by the control system causes the control system to perform the steps of
monitoring information from the gyro and accelerometer system in determining the amount of vibration on each solar wing, and
in response to the vibration on any of said solar wings exceeding a threshold,
initiating the solar wings to rotate to reducing the air turbulence for a more laminar flow of wind flow through the solar tower.

9. The solar tower installation of claim 7, wherein the gyro and accelerometer system is configured to determine an oscillation of the solar tower, wherein the non-transitory memory further contain instructions when executed by the control system causes the control system to perform the steps of
monitoring information from the gyro and accelerometer system in determining the amount of oscillation of the solar tower, and
in response to the oscillation exceeding a threshold, initiating one or more of the solar wings to rotate and open several degrees to change the laminar flow around the airfoil.

10. The solar tower installation of claim 1, wherein the base includes a bottom section, and wherein the bearing assembly is connected to the bottom section enabling the tower structure to rotate.

11. The solar tower installation of claim 1, wherein the tower structure includes a lower portion including the base, said lower portion being fixed, and an upper portion including the solar wings, and
wherein the bearing assembly is connected between the upper portion and lower portion enabling the upper portion of the tower structure to rotate.
